(19) United States
(12) Patent Application Publication
(10) Pub. No.: US 2025/0303597 A1
(43) Pub. Date: Oct. 2, 2025

(54) RAZOR BLADES HAVING ANTIMICROBIAL SOFT COATING

(71) Applicant: The Gillette Company LLC, Boston, MA (US)

(72) Inventor: Ronald Richard Duff, JR., Shrewsbury, MA (US)

(21) Appl. No.: 19/090,687

(22) Filed: Mar. 26, 2025

Related U.S. Application Data
(60) Provisional application No. 63/572,655, filed on Apr. 1, 2024.

(51) Int. Cl. B26B 21/60; B26B 21/40

(52) U.S. Cl. CPC B26B 21/60; B26B 21/4068

(57) ABSTRACT

A razor blade with a substrate having a cutting edge and a soft coating disposed on at least a portion of the substrate or on an intermediate layer itself disposed on at least a portion of the substrate. The soft coating including a lubricious material and an antibacterial additive selected from the group consisting of one or more metals, one or more metal salts, and mixtures thereof. The metal is selected from the group consisting of silver, copper, zinc, cobalt, nickel, zirconium, and molybdenum. The metal salt is selected from the group consisting of silver salts, copper salts, zinc salts, and calcium salts.

### FIELD OF THE INVENTION

The invention relates generally to razor blades for handheld razor products having a durable antimicrobial soft coating on the blade, and to a method of making such coated blades.

### BACKGROUND OF THE INVENTION

Hand-held razor products include, among other things, a razor blade. The blade is typically formed of a suitable substrate material, such as stainless steel. The blade has a cutting edge defined in relevant part by a wedge-shaped configuration with an ultimate tip, typically having a radius less than about 1000 angstroms (Å), e.g., about 200-300 Å.

Consumers of these products value certain characteristics of these products and the blade. Among those characteristics are suitable strength, corrosion resistance, and shaving ability. To better ensure or impart these characteristics to the blade, manufacturers often apply to the blade substrate one or more hard coatings, such as diamond, amorphous diamond, diamond-like carbon (DLC) material, nitrides, carbides, oxides, borides, or ceramics. Other desirable characteristics include lubricity and reduced friction as the blade traverses the skin (cutting surface). To better ensure or impart these characteristics to the blade, manufacturers often apply to the blade substrate, or another coated layer of the blade, one or more soft coatings generally including a polymeric material, such as polytetrafluoroethylene (PTFE).

In addition to the above-noted coatings, the blade may include interlayers of niobium or chromium-containing materials. These interlayers may potentially aid in improving the bonding between the blade substrate and hard and soft coatings. These interlayers also may assist in reducing tip rounding.

The coatings may be applied using any suitable method known in the razor blade manufacturing field. For example, physical vapor deposition (PVD) techniques are often used to apply the hard coating(s), and dipping, spraying, and/or brushing are techniques that can be used to apply the soft coating(s). Depending upon their chemical composition, the interlayers may be applied by these hard- and soft-coating techniques. Examples of razor blades and processes of manufacture are described in U.S. Pat. Nos. 5,295,305, 5,232,568, 4,933,058, 5,032,243, 5,497,550, 5,940,975, and 5,669,144; European Patent No. 0 591 339 B; and International Patent Application Publication No. WO 1992/019425. The content of each of these publications is hereby incorporated by reference.

Personal care articles can be susceptible to microbial growth, especially after repeated use. In particular, hand-held razor products can be susceptible to microbial growth, in particular bacterial growth, as well as growth of mold, fungus, or viruses. Further, microbial growth on the blade, handle, or other components of a razor product is unsanitary and visually unappealing. Rinsing a razor product, after its use, may help mitigate microbial growth. However, rinsing may not sufficiently remove the microbial growth, and the user may not be able to readily determine if microbial growth is present after rinsing. In addition, in some regions of the world, running water can be limited. The art still lacks practical ways to help reduce or prevent microbial growth.

An antibacterial additive applied to or included in only the external surface or external-most coating of a razor blade may not offer sufficient antibacterial efficacy for the expected lifetime of the blade's use as part of a razor product. The additive so applied or included may simply wear away from the blade surface after a few uses, leaving a blade surface that would be susceptible to bacterial growth. A separately applied layer or coating exhibiting antibacterial properties may result in a rough cutting surface and an uncomfortable shaving experience. As noted above, a soft polymeric coating may be applied to a razor blade. Including an organic antibacterial agent in the application of such a coating would likely result in a soft coating and blade having low antibacterial efficacy, at least because organic antibacterial agents are typically unstable at the high temperatures often used to produce such soft coatings.

There remains a need for a razor blade that provides a low-friction external surface while exhibiting an antibacterial effect that is maintained over a longer period of time than the art has currently been able to offer, and preferably for the duration of the product's useful life, without negatively impacting overall shave performance.

### SUMMARY OF THE INVENTION

Disclosed herein is a razor blade having improved antibacterial efficacy. The razor blade generally includes a substrate having a cutting edge and a soft coating. The soft coating is disposed on at least a portion of that substrate or on an intermediate layer that may be disposed on at least a portion of the substrate. The soft coating includes a lubricious material and a metal-containing antibacterial additive. More specifically, the additive includes one or more metals or one or more metal salts. The additive can also include both metals and metal salts. These metals or metal salts inhibit bacterial growth. The metals include silver, copper, zinc, cobalt, nickel, zirconium, molybdenum, and mixtures thereof. The metal salts include silver salts, copper salts, zinc salts, calcium salts, and mixtures thereof.

Also disclosed herein is a method of making the razor blade. The method of making the razor blade includes providing a substrate having a cutting edge and depositing the soft coating on at least a portion of the substrate or on an intermediate layer itself disposed on at least a portion of the substrate. As explained above, the soft coating includes a lubricious material and a metal-containing antibacterial additive.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Features and advantages of the invention will be apparent from the following detailed description, and from the claims.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. The drawings may have been simplified by the omission of selected elements for the purpose of more clearly showing other elements. Such omissions of elements are not necessarily indicative of the presence or absence of particular elements in any of the exemplary embodiments, except as may be explicitly delineated in the corresponding written description. The drawings are not necessarily to scale.

FIG. 1 is a perspective view of a razor having a cartridge and a handle and blade edges having a soft coating disposed thereon.

FIG. 2 is a side view of a blade edge of FIG. 1.

FIG. 3 is a flowchart describing a method for making a razor blade.

### DETAILED DESCRIPTION OF THE INVENTION

Disclosed herein is a coated razor blade that provides a low-friction external surface while exhibiting an antibacterial effect that is maintained over a longer period of time than the art has heretofore been able to offer, and preferably for the duration of the razor blade's useful life.

The razor blade has a soft coating. The soft coating contains one or more lubricious materials that provide a low-friction surface to the coating. The soft coating also contains an antibacterial additive. The antibacterial additive includes one or more metals, one or more metal salts, or a combination thereof, that can impart to the soft coating and blade an antibacterial effect, such as inhibition of bacterial growth. The metals are selected from the group consisting of silver, copper, zinc, cobalt, nickel, zirconium, molybdenum, and mixtures thereof. The metal salts are selected from the group consisting of silver salts, copper salts, zinc salts, calcium salts, and mixtures thereof.

The method of making this razor blade includes providing a substrate having a cutting edge and depositing the soft coating on at least a portion of the substrate or on an intermediate layer itself disposed on at least a portion of the substrate. As explained above, the soft coating includes a lubricious material and a metal-containing antibacterial additive.

While stainless steel is the desired substrate, as it is the common substrate for razor blades, blade substrates comprised of another metal or metals, ceramic, polymeric materials, glass, diamond, silicon, or any combination thereof, are also contemplated. One substrate material which may facilitate producing an appropriately sharpened edge is a martensitic stainless steel with smaller more finely distributed carbides, but with similar overall carbon weight percent. A fine carbide substrate provides for a harder substrate with enhanced hardenability, with more brittleness after hardening, and enables the making of a thinner, stronger edge. An example of such a substrate material is a martensitic stainless steel with a finer average carbide size with a carbide density ranging from about 90 carbides per 100 square micrometers to about 1000 carbides or more per 100 square micrometers as determined by scanning electron microscopy (SEM). A cross-section image can be obtained by SEM at 4000 magnification or higher.

The razor blades described herein include a coating disposed substantially on the outer sides of the razor blade. A “layer” as used herein may signify at least one material on a razor blade satisfied by a variety of factors, including but not limited to, the composition, morphology, or structure of the layer(s); the presence of a boundary between layers; whether the process used to make the product is expected to result in one or more layers; and whether there is a sufficient change in composition or morphology as to result in one or more layers. As one example, there may be only one type of material on the razor blade but with distinguishable layers, each layer having a different morphology. As used herein, a “coating” may signify one or more layers on a razor blade, in which each layer comprises one or more materials. Thus, the “coating” may be defined by a single layer or by multiple layers. The term “coating” also signifies the overall or total coating on one side of the razor blade, which includes all of the layers on that one side of the razor blade.

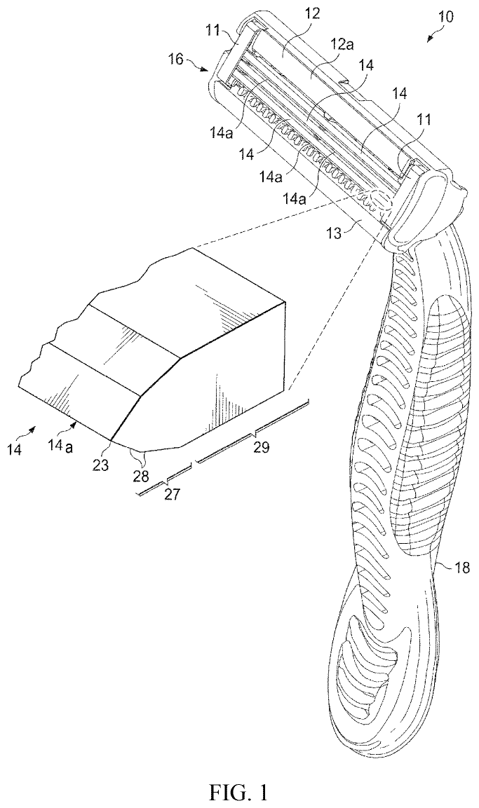

The term “razor blade” desirably signifies a “substrate” preferably made of stainless steel. The razor blade includes a blade body and at least one flank. Desirably, a razor blade includes two flanks forming a blade edge and a blade body. The two flanks intersect at a point or tip, or what is oftentimes referred to as the ultimate tip. Each flank may have one, two or more bevels. The blade body is generally the remaining area of the razor blade beneath the flanks or bevels. As shown in a call-out section of FIG. 1, blade 14 includes blade body 29, two bevels 28 for each of two flanks 27 which intersect at tip 23 forming a blade edge 14a. A “substrate” signifies the substance or material acted upon. Illustrative embodiments herein relate to a stainless-steel substrate, commonly used for razor blade formation.

Turning now to FIG. 1, a razor 10 generally includes a shaving or cartridge unit 16 attached to a handle 18 with the shaving unit 16 having one or more blades 14 (e.g., 3 blades shown) each with a sharpened edge 14a. A cap 12 and guard 13 may also be included in the shaving unit 16, the cap 12 preferably including a shaving aid composite 12a affixed thereon. The shaving unit 16 may be adapted for coupling and uncoupling from the razor handle 18 such that a new cartridge unit 16 may be coupled to the handle when the blades become dull or may be integral with a handle 18 so that the complete razor 10 is discarded when the blades become dull. It is noted that one or more of the blades 14 in FIG. 1 has a soft coating disposed thereon, preferably at least on a blade edge 14a. The soft coating can additionally be disposed on flanks 27 and blade body 29.

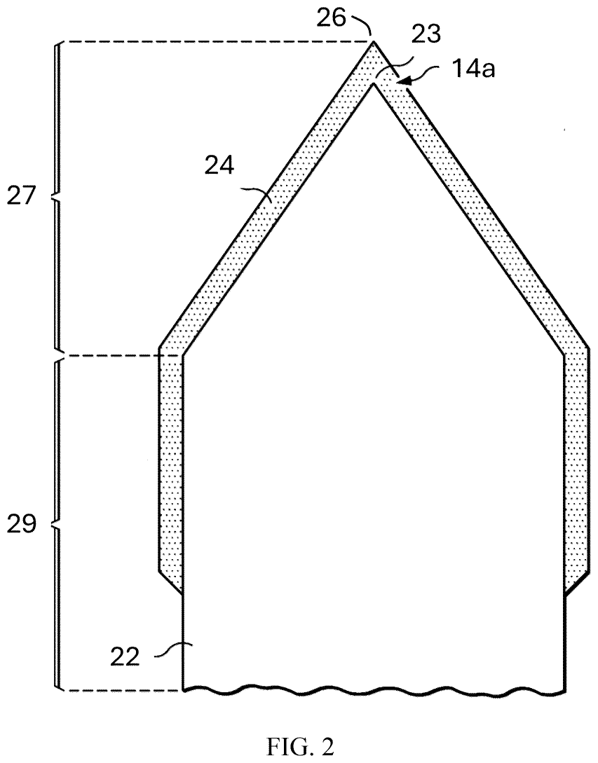

A side view of a blade or sharpened substrate is shown in FIG. 2. The blade 14 includes a stainless-steel substrate 22 with a sharpened blade edge 14a formed in a sequence of honing operations that forms a tip portion 23 with a radius typically less than 500 angstroms, flanks 27 which may or may not include one or more bevels 28, and blade body 29, as shown in the call-out section of FIG. 1. At least one soft coating 24 can be deposited on the tip portion 23 and flanks 27 of substrate 22. At least one soft coating 24 can be deposited on the tip portion 23, flanks 27, and a portion or all of the blade body 29, as shown in FIG. 2. The thickness of the soft coating 24 may desirably range from about 50 angstroms to about 5000 angstroms, and the soft coating may or may not be uniformly deposited on the blade 14. It should be noted that the soft coating may be deposited despite any variation in lengths of flanks 27, angles, and aspect ratios (e.g., the ratio of the distance from the blade tip portion 23 to the coated tip 26 and the width of the soft coating 24 at the tip portion 23).

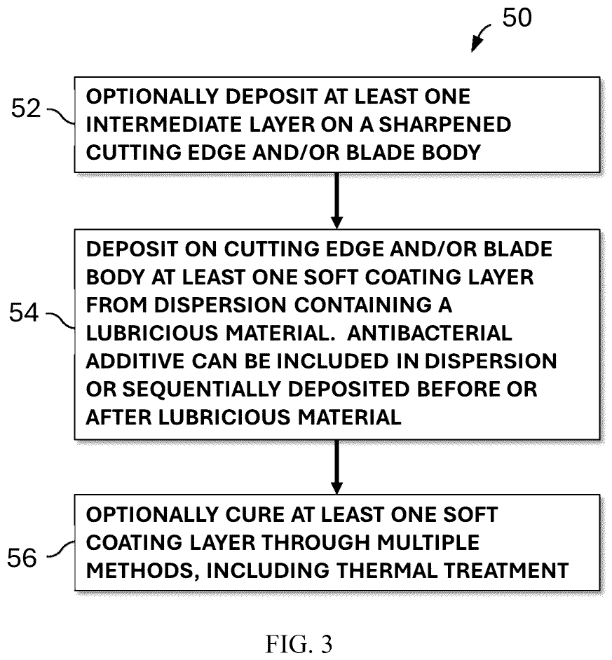

As previously explained, the method of making the razor blade includes providing a substrate having a cutting edge and depositing a soft coating on at least a portion of the substrate or on an intermediate layer itself disposed on at least a portion of the substrate. The soft coating includes a lubricious material and an antibacterial additive. FIG. 3 is a flow diagram describing this method. As shown in FIG. 3, the method 50 optionally includes first depositing at least one intermediate layer on a blade having a sharpened cutting edge and/or blade body, as described in 52. As previously explained, the intermediate layer(s) can include hard coatings to improve blade properties. As described in 54, at least one lubricious layer can then be deposited either on the blade substrate or on an intermediate layer. The lubricious layer(s) can be deposited as a dispersion either with or without antibacterial additives. If the lubricious layer(s) do not include an antibacterial additive, an antibacterial additive can be deposited on the blade either before or after deposition of the lubricious layer(s). An optional curing step 56, such as a thermal treatment, can be performed to improve properties of the lubricious layer(s) having an antibacterial additive.

### Soft Coatings

A soft coating is typically applied to the surface of the razor blade of a shaving product to reduce friction between the razor blade and the skin and impart lubricity. The soft coating includes a lubricious material and an antibacterial additive. The lubricious material aids in ensuring the soft coating has a low-friction surface. The lubricious material may include a polymeric material that is generally highly lubricious, such as a fluoropolymer (e.g., polytetrafluoroethylene (PTFE), often referred to as telomer), or may be comprised of a polymeric material or other materials that is/are generally more or less lubricious (e.g., having a coefficient of friction lesser or greater than that of PTFE, respectively). Providing a telomer (e.g., PTFE) on the outermost surface of the blade edge endows a user's skin with lubriciousness on contact.

Other suitable lubricious materials for the soft coating include other fluoropolymers, including but not limited to polyperfluoroalkoxyalkanes, fluorinated ethylene propylene, and polyethylene-tetrafluoroethylene. Non-fluorinated polymers, including but not limited to polyethylene, polypropylene, polyoxymethylene (acetal), and polyether ether ketone (PEEK), are also suitable as lubricious materials. Polyethylene can include any of high-density polyethylene (HDPE), low-density polyethylene (LDPE), very-low-density polyethylene (VLDPE), linear low-density polyethylene (LLDPE), and ultrahigh-molecular weight polyethylene (UHMWPE). Similarly, polypropylene can include any of atactic, isotactic, and syndiotactic polypropylenes. Non-polymeric materials, such as carbon (e.g., graphite) and non-polymeric hydrocarbon-based or fluorocarbon-based compounds, may also be suitable lubricious materials for the soft coating.

The soft coating is preferably less than 5,000 Å and could typically be 1,500 Å to 4,000 Å, and can be as thin as 50 Å, provided that a continuous coating is maintained. Provided that a continuous coating is achieved, reduced coating thickness can provide improved first shave results. U.S. Pat. Nos. 5,263,256 and 5,985,459, the contents of which are hereby incorporated by reference, describe techniques which can be used to reduce the thickness of an applied coating layer.

### Antibacterial Additives

The soft coating includes an antibacterial additive. The antibacterial additive includes one or more metals or metal salts that can impart an antibacterial effect to the soft coating, such as reduced susceptibility to bacterial growth compared to a soft coating that does not include this antibacterial additive. The metals include silver, copper, zinc, cobalt, nickel, zirconium, molybdenum, and mixtures thereof. The metal salts include salts of silver, copper, zinc, and calcium. A mixture of these metal salts can be used as well. Suitable silver salts include silver sulfate and silver nitrate. Suitable copper salts include copper sulfate. Suitable zinc salts include zinc sulfate and zinc citrate.

Without intending to be bound by theory, it is believed that certain metal ions are effective at killing bacteria or inhibiting bacterial growth and that certain metals exhibit antibacterial activity that derives at least in part from antibacterial activity of metal ions that can be present at a surface of the metal.

Hydroxide salts, such as calcium hydroxide, can be suitable antibacterial additives. Without intending to be bound by theory, hydroxide salts may interfere with bacterial growth by providing a high pH environment that is not conducive to bacterial function.

The antibacterial additive can be present in the soft coating in an amount sufficient to inhibit bacterial growth compared to a surface which does not have a soft coating containing an antibacterial additive. The amount of antibacterial additive can be expressed in terms of the amount of metal or metal ion present in the soft coating. In embodiments in which the antibacterial additive is a metal, the weight ratio of lubricious material in the coating to metal in the coating can be from about 100:1 to about 2:1, or from about 20:1 to about 3:1, or from about 6:1 to about 4:1. In embodiments in which the antibacterial additive is a metal salt, the weight ratio of lubricious material in the coating to metal ion comprising the metal salt in the coating can be from about 100:1 to about 2:1, or from about 20:1 to about 3:1, or from about 6:1 to about 4:1. For instance, in embodiments in which the antibacterial additive is a silver salt, the weight ratio of lubricious material to silver ion can be from about 100:1 to about 2:1, or from about 20:1 to about 3:1, or from about 6:1 to about 4:1.

In certain embodiments, the antibacterial additive includes a metal salt having a solubility of at least about 0.1 g/L in water at 20° C. In certain embodiments, the antibacterial additive includes a metal salt having a solubility of at least about 1 g/L in water at 20° C.

### Intermediate Layers

As noted above, the razor blades can optionally include one or more intermediate layers disposed between the substrate and the soft coating. The one or more intermediate layers can include a hard coating that is applied to the substrate, particularly the cutting edge, to improve strength, corrosion resistance, and shaving ability and to maintain needed strength while permitting thinner edges with lower cutting forces to be used. The hard coating can include one or more layers and can contain diamond, amorphous diamond, diamond-like carbon (DLC) material, chromium-containing material, nitrides, carbides, oxides, borides, ceramics, or a mixture thereof. In certain embodiments, the hard coating includes a layer containing a chromium-containing material. The hardness, strength, and structural properties of the hard coating, in addition to imparting a benefit to tip-shaping capability, can provide significant benefits on razor blade edges, such as very low cutting forces.

The hard coating may include one or more additives which may have some impact on its properties. The additives may generally include, but are not limited to, one or more of a polymeric material, a ceramic material, a metal, silicon, boron, carbon, or any combination thereof. These additives may be evenly dispersed through the hard coating or may increase or decrease in amount in the direction towards the outer surface of the hard coating.

In additional embodiments, the hard coating further includes at least one interlayer disposed between the substrate and the hard coating. An interlayer can, for instance, facilitate bonding of the hard coating to the substrate. Examples of suitable interlayer materials are polymeric material, niobium, chromium, platinum, titanium, silicon, tantalum, tungsten, molybdenum, carbon, boron, and mixtures or alloys thereof. A particular interlayer is made of niobium and is greater than 100 angstroms and preferably less than 500 angstroms thick.

Techniques for applying a hard coating or an interlayer to a razor blade may desirably include physical vapor deposition (PVD) techniques known in the art, such as magnetron sputtering, continuous or pulsed DC sputtering, or RF sputtering. Substrate bias voltages during sputtering can range from about 0 volts to −1000 volts DC (−1000 VDC). The targets containing the source material(s) to be deposited on the blades used in sputtering processes can be formed as homogeneous or mixed material targets, depending on the material(s) to be deposited. Co-sputtering is also contemplated, wherein two or more individual source materials are sputtered from separate targets, either at once or in sequence in a sputtering chamber. Additionally, other methods known in the art, such as chemical vapor deposition (CVD) and cathodic arc deposition, are also contemplated as applicable processing techniques to deposit a hard coating or an interlayer.

Hard coatings deposited on blade substrates may beneficially provide for the formation of a wide range of possible tip shapes. The resultant coating tip geometry is highly sensitive to the substrate bias voltage applied during the sputtering process. For instance, at a substrate bias voltage in the range between 0 VDC and −250 VDC, the tip shape is generally blunt or rounded, having a tip radius of generally greater than 300 angstroms, while at a substrate bias voltage range between −250 VDC and −1000 VDC, the tip shape is generally pointed or sharp, having a tip radius generally less than or equal to 300 angstroms.

### Method of Applying a Soft Coating

The soft coating can be applied directly on the blade substrate or on an intermediate layer that is disposed on the substrate. The method of applying the soft coating includes providing a substrate having a cutting edge and depositing the soft coating on at least a portion of the substrate or on an intermediate layer itself disposed on at least a portion of the substrate. The soft coating includes a lubricious material and an antibacterial additive.

Depositing the soft coating on the substrate, or on one or more intermediate layers disposed on the substrate, can include applying a liquid-based dispersion (i.e., an aqueous or solvent-based dispersion) containing the lubricious material and the antibacterial additive to the substrate, or to the one or more intermediate layers disposed on the substrate, to ultimately form a coating layer containing the lubricious material and the antibacterial additive. The dispersion can be applied by any suitable means, including spraying, dipping, or brushing. In certain embodiments, the dispersion is sprayed onto the substrate forming the coating layer. In certain embodiments, the coating layer is heated at a temperature sufficient to melt and/or sinter the lubricious material(s) in the coating layer to form the soft coating. In particular, the coating layer may be heated to at least about 250° C., or at least about 300° C., or at least about 350° C., or at least about 400° C. In certain embodiments, the lubricious material has a melting temperature, and the coating layer is heated to at least the melting temperature of the lubricious material. In further embodiments, the substrate is pre-heated, for example to at least about 100° C., or at least about 110° C., or at least about 120° C., or at least about 130° C., or at least about 150° C., or at least about 160° C., or to the temperature at which the applied coating is eventually heated, before applying the dispersion to the substrate.

In certain embodiments, the liquid-based dispersion is an aqueous dispersion, and the antibacterial additive includes a metal salt having a solubility of at least about 0.1 g/L in water at 20° C. In certain embodiments, the liquid-based dispersion is an aqueous dispersion, and the antibacterial additive includes a metal salt having a solubility of at least about 1 g/L in water at 20° C. In certain embodiments, the liquid-based dispersion is an aqueous dispersion, and the antibacterial additive is fully soluble in the aqueous dispersion.

In certain embodiments, the soft coating forms the outermost layer of the coated razor blade.

The soft coating may be applied in a single step where the dispersion contains both the lubricious material and the antibacterial additive. Alternatively, separate mixtures of the soft coating dispersion, each containing either the lubricious material or the antibacterial additive, may be applied separately or sequentially to thereafter form a combined soft coating. The soft coating can be present on the sharpened blade edge, and optionally on one or more flanks comprising the blade, and optionally on the blade body. Without intending to be bound by theory, it is believed that a soft coating in which an antibacterial additive is dispersed throughout can continue to provide antibacterial efficacy throughout the lifetime of the article, even if the soft coating partially wears away as a result of repeated use of the article.

### Test Methods and Results

The soft coating comprising an antibacterial additive can be characterized by a log kill ratio against particular bacteria. For instance, a soft coating may exhibit a log kill ratio against E. coli, S. aureus, or other bacteria of interest.

Log kill ratios against S. aureus and E. coli were measured according to the internationally recognized ISO-22196 method, used to determine antibacterial activity of non-porous surfaces. Bacterial colony counts on at least three 50×50 mm coupons having a PTFE coating not containing an antibacterial additive (as negative controls and a baseline) were compared to bacterial colony counts on three 50×50 mm coupons having a PTFE coating containing an antibacterial additive (experimental samples) over 24 hours. Inocula containing S. aureus ATCC 6538 or E. coli ATCC 8739 were prepared in PBS (phosphate-buffered saline) (% transmittance @425 nm: S. aureus 23-25%, E. coli 31-33%) and diluted in nutritive broth to 1/500NB (1:100). Then 0.3 mL of diluted inoculum was dispensed onto each 50×50 mm coupon, and a 40×40 mm cover film was placed on top to ensure the inoculum visibly dispersed over the coupon inside a 90 mm petri dish. To provide a time zero (T=0) baseline bacterial colony count, three negative control samples were sampled immediately by adding 10 mL MLTB (neutralizer) and serially diluting to 10⁻⁶ M saline, and 0.5 mL of the resulting solution was spread onto TSA (tryptic soy agar) and incubated at 32.5° C. overnight, before counting bacterial colonies according to standard methods. Another negative control sample and the experimental samples were incubated for 24 hours at 32.5° C. in humified conditions and then sampled in the same manner as the T=0 coupons to determine bacterial colony counts. The log kill ratio for the experimental samples is the logarithm of the ratio of the average bacterial colony count on the negative controls to the average bacterial colony count on the experimental samples.

A razor blade according to the disclosure can exhibit a log kill ratio against E. coli of at least about 2.0, or at least about 4.0. A razor blade according to the disclosure can exhibit a log kill ratio against S. aureus of at least about 2.0, or at least about 4.0. A razor blade according to the disclosure can exhibit a log kill ratio against E. coli of at least about 4.0 and a log kill ratio against S. aureus of at least about 4.0.

In a specific test, 50×50 mm atomically flat silicon coupons were coated with PTFE not containing an antibacterial additive (“neat PTFE”) or with PTFE containing 20 wt. % silver ion, added as Ag₂SO₄ (“PTFE/Ag₂SO₄”) and evaluated according to the ISO-22196 method. Results of these tests showed a full kill of both S. aureus and E. coli on the PFTE/Ag₂SO₄ samples, with log kill ratios vs. the neat PTFE samples of 4.3 for S. aureus and 6.1 for E. coli.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A razor blade comprising:
(a) a substrate having a cutting edge; and
(b) a soft coating disposed on at least a portion of the substrate or on an intermediate layer itself disposed on at least a portion of the substrate, said soft coating comprising a lubricious material and an antibacterial additive selected from the group consisting of one or more metals, one or more metal salts, and mixtures thereof, wherein:
(i) the metal is selected from the group consisting of silver, copper, zinc, cobalt, nickel, zirconium, and molybdenum; and,
(ii) the metal salt is selected from the group consisting of silver salts, copper salts, zinc salts, and calcium salts.

2. The razor blade of claim 1, wherein the antibacterial additive comprises a metal, and the weight ratio of the lubricious material to the metal is in a range of about 100:1 to about 2:1.

3. The razor blade of claim 2, wherein the weight ratio is in a range of about 20:1 to about 3:1.

4. The razor blade of claim 3, wherein the weight ratio is in a range of about 6:1 to about 4:1.

5. The razor blade of claim 1, wherein the antibacterial additive comprises a metal salt and the weight ratio of the lubricious material to the metal ion comprising the metal salt is in a range of about 100:1 to about 2:1.

6. The razor blade of claim 5, wherein the weight ratio is in a range of about 20:1 to about 3:1.

7. The razor blade of claim 6, wherein the weight ratio is in a range of about 6:1 to about 4:1.

8. The razor blade of claim 1, wherein the antibacterial additive includes a metal salt having a solubility of at least about 0.1 g/L in water at 20° C.

9. The razor blade of claim 8, wherein the metal salt has a solubility of at least about 1 g/L in water at 20° C.

10. The razor blade of claim 1, wherein the antibacterial additive comprises silver sulfate.

11. The razor blade of claim 1, wherein the antibacterial additive comprises copper sulfate.

12. The razor blade of claim 1, wherein the soft coating is the outermost coating comprising the razor blade.

13. The razor blade of claim 1, wherein the lubricious material is selected from the group consisting of fluoropolymers, polyethylene, polypropylene, polyoxymethylene (acetal), polyether ether ketone (PEEK), carbon, hydrocarbons, fluorocarbons, and combinations thereof.

14. The razor blade of claim 13, wherein the lubricious material comprises one or more fluoropolymers selected from the group consisting of polytetrafluoroethylene, polyperfluoroalkoxyalkanes, fluorinated ethylene propylene, polyethylene-tetrafluoroethylene, and mixtures thereof.

15. The razor blade of claim 14, wherein the lubricious material comprises polytetrafluoroethylene.

16. The razor blade of claim 1, wherein the soft coating is disposed directly on the substrate.

17. The razor blade of claim 1, wherein the intermediate layer is present and comprises a hard coating.

18. The razor blade of claim 17, wherein the hard coating comprises a layer containing a chromium-containing material.

19. The razor blade of claim 18, wherein the hard coating further comprises at least one interlayer disposed between the substrate and the layer containing the chromium-containing material.

20. The razor blade of claim 19, wherein the at least one interlayer comprises polymeric material, niobium, chromium, platinum, titanium, silicon, tantalum, tungsten, molybdenum, carbon, boron, or any mixtures or alloys thereof.
